(19) United States
(12) Patent Application Publication
(10) Pub. No.: US 2026/0031507 A1
(43) Pub. Date: Jan. 29, 2026

(54) CYLINDRICAL SECONDARY BATTERY AND METHOD AND APPARATUS FOR MANUFACTURING THE SAME

(71) Applicant: Samsung SDI Co., Ltd., Yongin-si (KR)

(72) Inventors: Hoejun Heo, Yongin-si (KR); JAEHOON ROH, Yongin-si (KR); Kyeongseon Yoo, Yongin-si (KR); Seongbae An, Yongin-si (KR); Taejin Yoon, Yongin-si (KR); Siyoung Lee, Yongin-si (KR)

(21) Appl. No.: 19/249,859

(22) Filed: Jun. 25, 2025

(30) Foreign Application Priority Data
Jul. 23, 2024 (KR) 10-2024-0097266

(51) Int. Cl. H01M 50/536; B23K 26/21; B60L 50/64; H01M 50/107

(52) U.S. Cl. CPC H01M 50/536; B23K 26/21; H01M 50/107; B60L 50/64; H01M 2220/20

(57) ABSTRACT

A method of manufacturing a cylindrical secondary battery includes manufacturing an electrode assembly including an electrode plate having an uncoated portion; positioning and arranging a current collector on the uncoated portion of the electrode assembly; positioning and arranging a lead tab on the current collector; and electrically connecting the uncoated portion, the current collector, and the lead tab.

### CROSS-REFERENCE TO RELATED APPLICATION

The present application claims priority to and the benefit of Korean Patent Application No. 10-2024-0097266, filed on Jul. 23, 2024, in the Korean Intellectual Property Office, the entire disclosure of which is incorporated herein by reference.

### BACKGROUND

### 1. Field

Aspects of embodiments of the present disclosure relate to a cylindrical secondary battery, and a method and apparatus for manufacturing the same.

### 2. Description of Related Art

Different from primary batteries that are not designed to be charged, secondary batteries are designed to be charged and discharged. A secondary battery generally includes an electrode assembly including (or consisting of) a positive electrode plate, a separator, and a negative electrode plate, a case (or can) for accommodating the electrode assembly, a substrate tab extending from an uncoated portion of each electrode plate of the electrode assembly, and an external terminal connected to the substrate tab.

A cylindrical secondary battery is manufactured by accommodating an electrode assembly and an electrolyte inside a roughly cylindrical case and sealing the case with a cap assembly. The electrode assembly may include a separator and a first electrode and a second electrode positioned with the separator interposed therebetween, and may be wound in a jelly-roll shape.

The above information disclosed in this Background section is for enhancement of understanding of the background of the present disclosure, and therefore, it may contain information that does not constitute a related (or prior) art.

### SUMMARY

Embodiments of the present disclosure are directed to a cylindrical secondary battery manufactured without using the conventional two-step (or two-time) electrical connection by e.g., welding an uncoated portion-current collector-lead tab of a cylindrical battery in one process.

According to an embodiment of the present disclosure, a method of manufacturing a cylindrical secondary battery includes manufacturing an electrode assembly including an electrode plate having an uncoated portion, positioning and arranging a current collector on the uncoated portion of the electrode assembly, positioning and arranging a lead tab on the current collector, and electrically connecting the uncoated portion, the current collector, and the lead tab together with one laser welder.

According to another embodiment of the present disclosure, an apparatus for manufacturing a cylindrical secondary battery includes a unit configured to position and arrange a current collector on an uncoated portion of an electrode plate of an electrode assembly, a unit configured to position and arrange a lead tab on the current collector, a pressing pusher configured to press the current collector to be in close contact with the lead tab, and an electrical connecting unit configured to electrically connecting the uncoated portion, the current collector, and the lead tab together.

According to another embodiment of the present disclosure, a secondary battery includes: a case; an electrode assembly accommodated in the case, the electrode assembly including a first electrode, a separator, and a second electrode; a current collector electrically connected to an uncoated portion of the first electrode of the electrode assembly, on which no active material is applied; a lead tab electrically connected to the current collector; and a terminal electrically connected to the lead tab.

According to another embodiment of the present disclosure, a pressing pusher including a part configured to bring an uncoated portion of an electrode assembly of a secondary battery, a current collector positioned and arranged on the uncoated portion, and a lead tab positioned and arranged on the current collector into close contact with each other before electrically connecting is performed thereto.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a cross-sectional view of a conventional cylindrical secondary battery;

FIG. 2A is a conceptual diagram of a cylindrical secondary battery according to embodiments of the present disclosure;

FIG. 2B is a conceptual diagram of a cylindrical secondary battery according to other embodiments of the present disclosure;

FIGS. 3A and 3B are schematic diagrams describing a welding method of an uncoated portion, a current collector, and a lead tab according to embodiments of the present disclosure;

FIG. 4 is a diagram of an electrode assembly assembled with the current collector and the lead tab, according to embodiments of the present disclosure;

FIG. 5A is a diagram of a pressing pusher used for one-time welding between the uncoated portion, the current collector, and the lead tab of an electrode assembly according to embodiments of the present disclosure;

FIG. 5B is a diagram describing a one-time welding method of the uncoated portion-current collector-lead tab according to embodiments of the present disclosure;

FIG. 5C is a diagram showing a state in which welding is completed according to embodiments of the present disclosure;

FIG. 6 is a flowchart describing a welding process of the uncoated portion, the current collector, and the lead tab of the electrode assembly of a cylindrical battery according to embodiments of the present disclosure;

FIG. 7 is a diagram illustrating a secondary battery module including secondary batteries manufactured according to embodiments of the present disclosure;

FIG. 8 is a diagram illustrating a secondary battery pack including the secondary battery module shown in FIG. 7; and

FIG. 9 is a conceptual diagram illustrating a vehicle in which the secondary battery pack shown in FIG. 8 is installed.

### DETAILED DESCRIPTION

Hereinafter, embodiments of the present disclosure will be described, in detail, with reference to the accompanying drawings. The terms or words used in the present specification and claims should not to be narrowly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

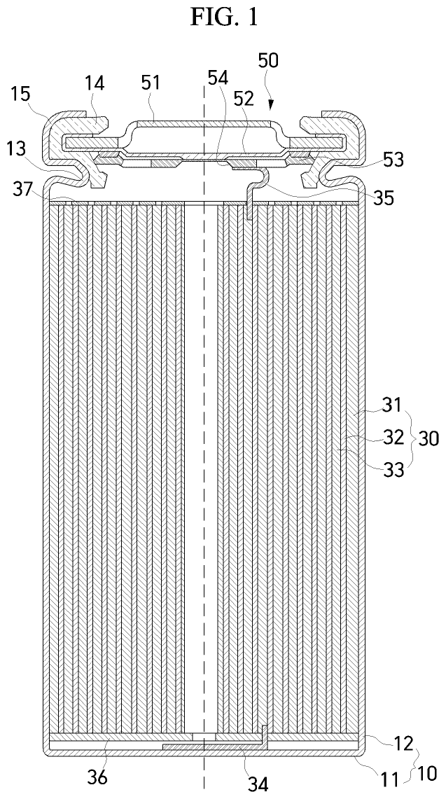

FIG. 1 illustrates a cylindrical secondary battery. Referring to FIG. 1, the secondary battery includes an electrode assembly 30, a case 10 accommodating the electrode assembly 30 and an electrolyte therein, a cap assembly 50 coupled to an opening in (e.g., an open end of) the case 10 to seal the case 10, and an insulating plate 37 positioned between the electrode assembly 30 and the cap assembly 50 inside the case.

The electrode assembly 30 may include a separator 32 and a first electrode 33 and a second electrode 31 positioned with the separator 32 interposed therebetween and may be wound in a jelly-roll shape.

The first electrode 33 includes a first substrate and a first active material layer on the first substrate. A first lead tab 35 may extend outwardly from a first uncoated portion of the first substrate at where the first active material layer is not located, and the first lead tab 35 may be electrically connected to the cap assembly 50.

The second electrode 31 includes a second substrate and a second active material layer on the second substrate. A second lead tab 34 may extend outwardly from a second uncoated portion of the second substrate at where the second active material layer is not located, and the second lead tab 34 may be electrically connected to the case. The first lead tab 35 and the second lead tab 34 may extend from the electrode assembly 30 in opposite directions.

The first electrode 33 may act as a positive electrode. In such an embodiment, the first substrate may be made of, for example, an aluminum foil, and the first active material layer may include, for example, a transition metal oxide. The second electrode 31 may act as a negative electrode. In such an embodiment, the second substrate may be made of, for example, a copper foil or a nickel foil, and the second active material layer may include graphite, for example.

The separator 32 prevents a short circuit between the first electrode 33 and the second electrode 31 while allowing movement of lithium ions therebetween. The separator 32 may be made of, for example, a polyethylene film, a polypropylene film, a polyethylene-polypropylene film, or the like.

The case 10 accommodates the electrode assembly 30 and, together with the cap assembly 50, forms the external appearance of the secondary battery. The case 10 may have a substantially cylindrical body portion 12 and a bottom portion 11 at (or connected to) one side (e.g., at one end) of the body portion 12. A beading part 13 (e.g., a bead) deformed inwardly may be formed in the body portion 12, and a crimping part 15 (e.g., a crimp) bent inwardly may be formed at an open end of the body portion 12.

The beading part 13 can reduce or prevent movement of the electrode assembly 30 inside the case 10 and can facilitate seating of the gasket 14 and the cap assembly 50. The crimping part 15 may firmly fix the cap assembly 50 by pressing the edge of the case 10 against the gasket 14. The case 10 may be formed of iron plated with nickel, for example.

The cap assembly 50 may be fixed to the inside of the crimping part 15 by a gasket 14 to seal the case 10. The cap assembly 50 may include a cap up 51, a safety vent 52, a cap down 53, an insulating member, and a sub plate 54 but is not limited thereto and may be modified in various ways.

The cap up 51 may be positioned at the uppermost part of the cap assembly 50. The cap up 51 may include a terminal part that protrudes upwardly and is connected to an external circuit, and an outlet for discharging gas may be arranged around the terminal part.

The safety vent 52 may be located under the cap up 51. The safety vent 52 may include a protrusion part that protrudes convexly downwardly and is connected to the sub plate 54, and at least one notch may be formed in the safety vent around the protrusion part.

When gas is generated due to overcharging or abnormal operation of the secondary battery, the protrusion part deforms upwardly in response to the pressure and separates from the sub plate 54 while the safety vent 52 is cut (e.g., bursts or tears) along the notch. The cut safety vent 52 may prevent the secondary battery from exploding by allowing the gas to be discharged to the outside.

The cap down 53 may be below the safety vent 52. The cap down 53 may have a first opening for exposing the protrusion part of the safety vent 52 and a second opening for gas discharge. The insulating member may be positioned between the safety vent 52 and the cap down 53 to insulate the safety vent 52 and the cap down 53.

The sub plate 54 may be under the cap down 53. The sub plate 54 may be fixed to a lower surface of the cap down 53 to block the first opening of the cap down 53, and the protrusion part of the safety vent 53 may be fixed to the sub plate 54. The first lead tab 35, which is drawn out from the electrode assembly 30 may be fixed to the sub plate 54. Accordingly, the cap up 51, the safety vent 52, the cap down 53, and the sub plate 54 may be electrically connected to the first electrode 33 of the electrode assembly 30.

The insulating plate 37 may be positioned to be in contact with the electrode assembly 30 below the beading part 13. The insulating plate 37 may have a tab opening through which the first lead tab 35 is drawn out. The cap assembly 50, which is electrically connected to the first electrode 33 by the first lead tab 35, may face the electrode assembly 30 with the insulating plate 37 interposed therebetween and may maintain a state of being insulated (e.g., electrically insulated) from the electrode assembly 30 by the insulating plate 37. Another insulating plate 36 may be included for insulation between the electrode assembly 30 and the bottom portion 11 of the case 10.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

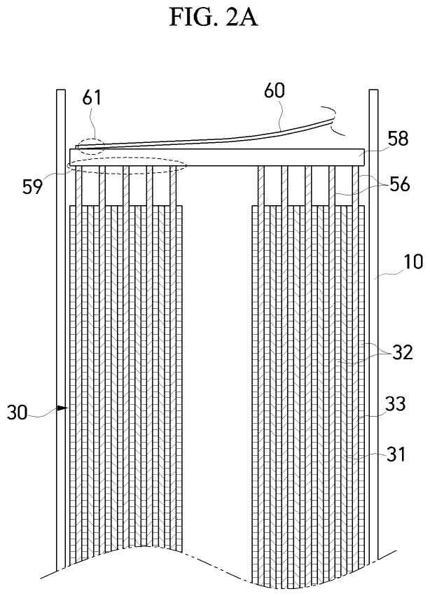

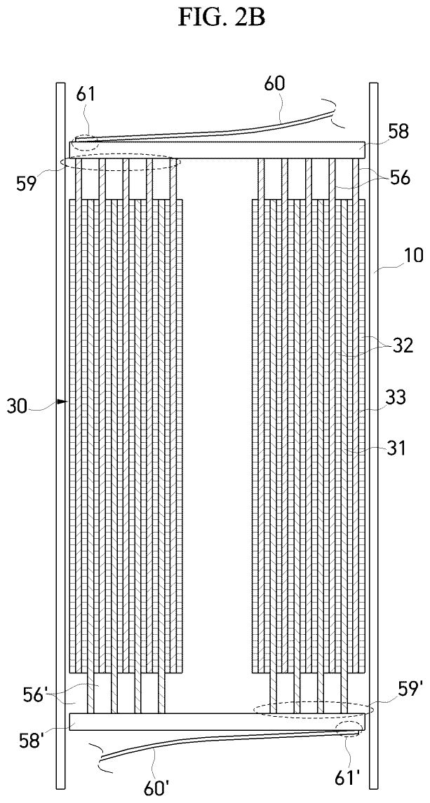

FIG. 2A is a conceptual diagram of a cylindrical secondary battery according to embodiments of the present disclosure.

An electrode assembly 30 may be accommodated inside a case 10. Similar to the cylindrical secondary battery shown in FIG. 1, the electrode assembly 30 may be a jelly-roll type electrode assembly in which a first electrode 33, a separator 32, and a second electrode 31 are wound. Here, the first electrode 33 may act as a positive electrode, and the second electrode 31 may act as a negative electrode, but the present disclosure is not limited thereto.

In the cylindrical secondary battery shown in FIG. 2A, a current collector 58 may be directly electrically connected to uncoated portions 56 of the first electrode 33. The electrically connected portions between the uncoated portions 56 and the current collector 58 are denoted as a first electrically connected portion 59. The electrical connection may be performed by, for example, welding, but not limited thereto.

A lead tab 60 may be electrically connected to an upper surface of the current collector 58 and connected to a terminal exposed to the outside. The electrically connected portion between the current collector 58 and the lead tab 60 is indicated as a second electrically connected portion 61. The electrical connection may also be performed by welding but not limited thereto.

Cylindrical batteries shown in FIGS. 2A and 2B are batteries in which a path through which electrons can move (e.g., current collectors) are expanded (or increased) and, therefore, exhibit ultra-high output (greater than about 65 A) and low resistance (about 10 mΩ or less) performance. Therefore, cylindrical batteries are used in high-output power tools, and the demand for them is growing worldwide.

A relatively wider area and thicker current collector is used, thereby enabling a current to be transmitted to the electrode assembly over a large area.

The cylindrical battery structure shown in FIG. 2A may include the second electrode 31 acting as a negative electrode. FIG. 2B shows an embodiment in which a method is applied to a negative electrode positioned at a lower portion of the secondary battery in addition to the positive electrode structure shown in FIG. 2A.

In the embodiment shown in FIG. 2B, a second current collector 58′ may be directly electrically connected to a second uncoated portion 56′ of the second electrode 31. Similar to the embodiment shown in FIG. 2A, a second lead tab 60′ may be electrically connected to a lower surface of the second current collector 58′.

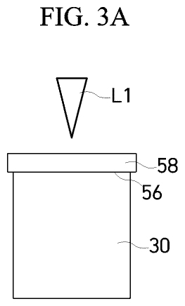

FIGS. 3A and 3B are schematic diagrams describing an electrical connection method of the uncoated portion 56, the current collector 58, and the lead tab 60. Hereinafter, the electrical connection described above will be described by way of example using a welding method. Welding can be performed using a laser beam. In addition, from now, the non-conductive portion 56, the current collector 58, and the lead tab 60 described below may include the second non-conductive portion 56′, the second current collector plate 58′, and the second lead tab 60′ as in FIG. 2b.

First, as shown in FIG. 3A, a current collector 58 may be welded to the uncoated portion 56 of the electrode assembly 30 by using a welder L1. Next, as shown in FIG. 3B, the lead tab 60 may be placed on the current collector 58 and welded thereto by using a welder L2.

The electrically connecting portions in the cylindrical secondary battery are: \textcircled{1} between the uncoated portion 56 of the electrode assembly 30 and the current collector 58; and \textcircled{2} between the current collector 58 and the lead tab 60. Thus, two welding processes are required, and therefore, two welding stations are required, which doubles the cost and time.

According to embodiments of the present disclosure, a one-time (or single step) welding method for welding the uncoated portion-current collector-lead tab of the electrode assembly at one time (e.g., concurrently or simultaneously) and an apparatus therefor are provided. For example, by changing the shapes of the current collector and the lead tab and the position of the electrically connecting portion, the uncoated portion-current collector-lead tab of the electrode assembly tab may be welded at once (e.g., welded at the same time).

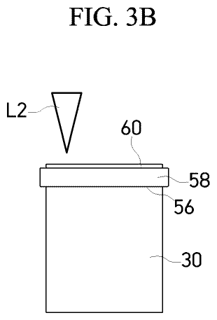

FIG. 4 shows an assembly of the electrode assembly 30, the current collector 58, and the lead tab 60, which are electrically connected according to embodiments of the present disclosure. The assembly of the electrode assembly 30, the current collector 58, and the lead tab 60 of FIG. 4 shows a current collector 58 electrically connected to the upper uncoated portion 56 of the first electrode 33 and a lead tab 60 electrically connected thereto, as shown in FIG. 2A. Similarly, a current collector 58′ electrically connected to the lower uncoated portion 56′ of the second electrode 31 and a lead tab 60′ electrically connected thereto, as shown in FIG. 2B, may also be easily implemented from FIG. 4.

The electrode assembly 30 may be manufactured in a form in which a separator is inserted between the positive electrode plate (substrate) and the negative electrode plate (substrate), each of which is coated with an active material, and wound in a cylindrical shape, and the uncoated portion (e.g., a substrate portion which is not coated with the active material) is exposed at an end portion of each electrode plate (here, the positive electrode plate).

The current collector 58 may be electrically connected to the uncoated portions 56 on the top of the electrode assembly 30. Referring to FIG. 4, because the current collector 58 is placed on the uncoated portions 56 on an upper surface of the stand-up (e.g., vertically positioned) electrode assembly 30 and welded thereto, the uncoated portions 56 are not visible.

The current collector 58 may have substantially a cylindrical sheet shape having a thickness thereof in a range from about 0.05 to about 0.30 mm and a diameter of about 19 mm, but these dimensions may vary depending on the specifications of the battery. The current collector 58 may be manufactured in a circular shape by pressing an aluminum (Al) plate by using a press mold, but the present disclosure is not limited thereto.

The lead tab 60 may be welded on the current collector 58. A shape of the lead tab 60 may be a rectangular sheet shape, but the present disclosure is not limited thereto. A thickness may range from about 0.05 to 0.30 mm, a length may range from about 10 to 20 mm, and a width may range from about 2 to 10 mm, but these dimensions may vary depending on specifications of the battery. The lead tab 60 may be manufactured by cutting an Al sheet rolled in a reel shape into a unit of about 6 mm wide.

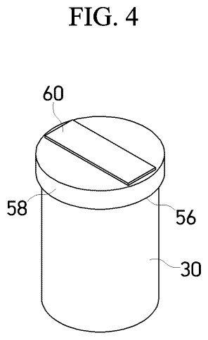

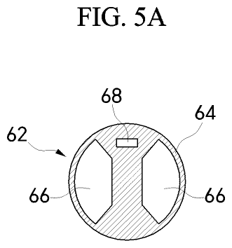

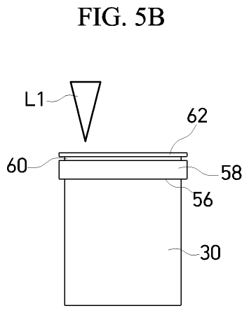

FIG. 5A shows a pressing pusher 62 for one-time welding performed to the uncoated portion 56, the current collector 58, and the lead tab 60 according to embodiments of the present disclosure.

According to embodiments of the present disclosure, because the current collector 58 and the lead tab 60 are placed on the uncoated portion 56 of the electrode assembly 30 and welding is performed above the current collector 58 and the lead tab 60, these respective members should be in close contact with each other to ensure sufficient welding quality. Otherwise, a gap may occur between the members, which may result in a non-weld, a weak weld, or holes. The pressing pusher 62 may be used to achieve or ensure close contact between the members.

The pressing pusher 62 may act as a pusher to ensure close contact as well as masking. To this end, the pressing pusher 62 may have a plate form (or shape) with an outer contour 64 (e.g., a circular shape) having a shape covering the current collector 58 and may have a first opening 66 opening (or exposing) a first electrically connected portion 59 that is the electrically connected portion between the uncoated portion 56 and the current collector 58 and a second opening 68 opening (or exposing) a second electrically connected portion 61 that is the electrically connected portion between the current collector 58 and the lead tab 60. The remaining region, except for the first opening 66 and the second opening 68, may be a blocking portion for blocking a laser beam during laser-based welding. The blocking portion may act as a press member for pressing the current collector 58 and the lead tab 60 toward each other.

FIG. 5B shows one-time (e.g., single step) welding performed on the uncoated portion 56-current collector 58-lead tab 60 according to embodiments of the present disclosure, and welding may be performed by placing the uncoated portion 56, the current collector 58, and the lead tab 60 of the electrode assembly 30 on each other from a bottom and pressing them with the pressing pusher 62. One-time welding may be performed with a single welder L1 in a state in which the members are pressed against each other by the pressing pusher 62. For example, the uncoated portion 56 and the current collector 58 may be welded together through the first opening 66 in the pressing pusher 62 with the welder L1, and the current collector 58 and the lead tab 60 may be welded together through the second opening 68 by moving the position of the welder L1. Therefore, the welding may be performed by using one welder at one station without changing the welder or transferring parts to be welded to another welding station.

FIG. 5C shows a state in which welding is completed according to the welding method as described above.

Because the drawing in FIG. 5C is a plan view illustrating a state in which the pressing pusher 62 is applied, the current collector 58 is not visible because the current collector 58 is positioned below (e.g., is covered by) an outer contour 64 of the pressing pusher 62, but the first electrically connected portion 59 of the uncoated portion 56 and the current collector 58 is visible through the first opening in the pressing pusher 62 and the second welding portion 61 of the current collector 58 and the lead tab 60 is visible through the second opening in the pressing pusher 62. Referring to FIG. 5C, the first welding portion 59 may be formed at six places with two lines each, and the second electrically connected portion 61 may be formed in two lines. However, the shape and quantity of the electrically connected portions are not limited thereto.

The masking by the pressing pusher 62 will be described in detail with reference to FIG. 5A again. To form electrically connected portions 59 (e.g., two lines per position) at six places on the current collector 58, the first opening 66 in the pressing pusher 62 may be formed have a size in a range of about 2 mm to about 5 mm in width and about 13 mm in length. When the size is smaller than the above dimensions, spatter (e.g., material melt) generated during melting by a laser beam may stick to the current collector 58, which may obstruct an emission path of the laser beam. To form at least one line of an electrically connected portion, the second opening 68 may be formed having a size in a range of about 2 mm to about 8 mm in width and in a range of about 1 mm to about 3 mm in length. When the size is smaller than the above dimensions, scattering ash generated during melting may be deposited on and may stick to the lead tab 60, which may obstruct an emission path of the laser beam.

First, the electrically connected portion 59 between the uncoated portion 56 and the current collector 58 of the electrode assembly 30 will be described in detail.

When the laser beam used is emitted in a line shape, the electrically connected portion 59 may be formed in six places with two lines each as shown in the drawings. A length of each line may range from about 1 mm to about 6 mm. When the length is about 1 mm or less, because a load of the electrically connected portion between the uncoated portion 56 and the current collector 58 is about 2 kgf or less, welding strength may not be secured, and additionally, a measured resistance value may be relatively high. When the length is about 6 mm or more, because a center (hollow core) of the electrode assembly 30 is empty by about 6 mm maximum, there is a concern in that the laser may be emitted to the empty center or away from the current collector 58.

A width of each welding line may be in range from about 0.1 mm to about 0.5 mm. When the width of the welding line is about 0.1 mm or less, a weak laser beam is emitted, and a welding load may be about 2 kgf or less or no welding may occur. When the width of the welding line is about 0.5 mm or more, an excessive laser beam is emitted, and the laser beam may pass through the uncoated portion 56 of the electrode assembly 30 and may be emitted to the separator, causing the separator to be melted.

A position of each welding line may be a point about 3 mm to about 8 mm away from the center of the electrode assembly. When the point is positioned about 3.0 mm or less from the center of the electrode assembly, because the center of the electrode assembly 30 is empty up to about 6 mm, the laser beam may be emitted to the empty center, and when the point is positioned about 8.0 mm or more from the center of the electrode assembly, because a length that can be melted for welding is 1 mm, welding strength may not be secured.

A melt depth of the welding line may range from about 0 to about 0.4 mm from a bottom of the current collector 58. When the melt depth is 0.0 mm, because the uncoated portion 56 and the current collector 58 are not welded, the welding portion may not have a load, and when the melt depth is about 0.4 mm or more, the separator may melt beyond the Al substrate of the uncoated portion 56, causing a short circuit due to contact between the positive electrode and the negative electrode.

In addition, the welding portion 61 between the current collector 58 and the lead tab 60 will be described in detail.

The welding portion may have a length of about 1 mm to about 10 mm, and when the laser beam is emitted in a line shape, the welding portion may have a width of about 0.1 mm to about 0.4 mm for a single line, a width of about 0.4 mm to about 0.8 mm (e.g., an interval of about 0.2 mm to about 0.4 mm) for two lines, and a width of about 0.8 mm to about 1.2 mm (e.g., an interval of about 0.2 mm to about 0.4 mm) for three lines. In the case of a welding portion having a length of about 1 mm or less, because the welding portion is short within the lead tab 60, which may have a length of about 2 mm to about 10 mm, welding strength may not be secured, and in the case a welding portion having a length of about 8 mm or more, because the welding may be performed away from the lead tab 60, which may have a length of about 2 mm to about 10 mm, the welding portion between the current collector 58-uncoated portion 56 may be irradiated with excessive heat, which may damage the separator within the electrode assembly 30.

A melt width may range from about 0.1 mm to about 0.5 mm. In the case of a melt width of about 0.1 mm or less, a weak laser beam has been emitted and the welding load is expected to be about 1 kgf or less and a measured resistance is expected to be high. In the case of a melt width of about 0.5 mm or more, an excessive laser beam has been emitted, which may have passed through the uncoated portion so that the separator is melted.

A position of the welding line may be a point about 4.0 mm to about 8.0 mm away from the center of the electrode assembly 30. When the point is about 4.0 mm or less from the center of the electrode assembly, because a height of the lead tab 60 that is bent for welding with the cap-up of the cylindrical battery (see, e.g., FIG. 1 and the description thereof) is about 12 mm or less, the welding cannot be performed between the lead tab and the cap-up member. When the point is about 8.0 mm or more from the center of the electrode assembly, the height of the lead tab 60 to be bent is about 18 mm or more, which may be too long and may cause a short circuit between the members.

A melt depth may range from 0 to about 0.7 mm from a bottom of the lead tab 60. When the melt depth is 0, the lead tab 60 and the current collector 58 are not welded, and no load of the welding portion may be generated. When the melt depth is between about 0 to about 0.3 mm, a melted portion may be formed only at an inside of the current collector 58, and a load of the welding portion may be formed in the range of about 1 kgf to about 5 kgf. Although an uncoated portion 56 and the current collector 58 may not be entirely welded, because the welding portion is formed between another uncoated portion (or another portion thereof) 56 and the current collector 58, a current flow is not interrupted but there is a possibility that the current collector 58-uncoated portion 56 may not be welded, in which case the current collector 58 may be lifted when strength of a welding portion between the lead tab 60 and the cap-up is measured. When the melt depth is about 0.3 mm to about 0.7 mm, the melted portion may be formed only on the uncoated portion 56, and a load of the welding portion ranging from about 1 kgf to 6 kgf may be formed. Because the uncoated portions 56 and the current collector 58 are welded, a current flow may easy flow therebetween. When the melt depth is about 0.7 mm or more, the separator may be melted, which may cause a short circuit due to contact between the positive electrode and a negative electrode.

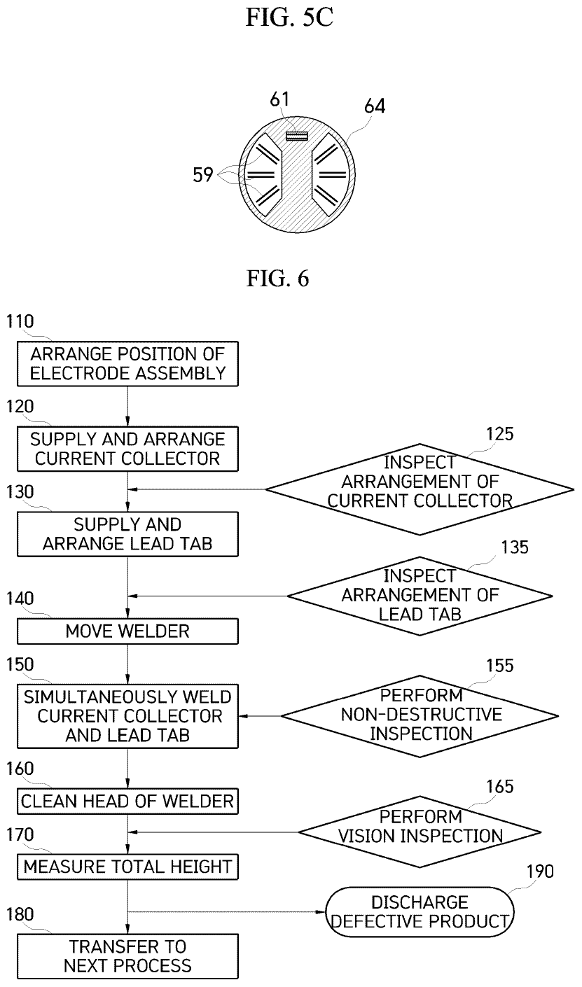

FIG. 6 is a flowchart describing a concurrent (or simultaneous) laser welding process of the uncoated portion 56, the current collector 58, and the lead tab 60 of the electrode assembly of a cylindrical battery according to embodiments of the present disclosure.

First, the electrode assembly 30 may be supplied to a conveyor and arranged on a working position (110). When the position of the electrode assembly 30 is positioned and arranged, whether or not there is a probability of dropping may be checked and an insertion direction may be considered.

The current collector 58 may be supplied and arranged with the uncoated portions 56 of the electrode assembly 30 (120). In this step, an arrangement state inspection of the current collector 58 may be performed (125). To this end, for example, a vision inspector or a sensor detector may be used.

The lead tab 60 may be supplied and arranged on the current collector 58 (130). In this step, an arrangement state inspection of the lead tab 60 may be performed (135). To this end, for example, a vision inspector or a sensor detector may be used.

A welder used for electrical connection may be moved (140).

One-time (e.g., single step) welding may be performed on the electrode assembly-current collector-lead tab (150). In this step, the pressing pusher 62 may press the current collector 58 and the lead tab 60 from the top to be in close contact with each other. Non-destructive inspection may be performed to verify the welding portion (155).

When the welding is completed, the welder head may be cleaned (160). In this step, vision inspection may be performed to inspect the welder head for contamination (165).

The overall height (or total height) of the electrode assembly 30, the current collector 58, and the lead tab 60, on which welding is completely performed, may be measured (170). To this end, for example, a laser range finder may be used. By measuring the total height, a subsequent case insertion and assembly process may be smoothly carried out and the welding state may be checked.

When the total height measurement is determined to be sufficient, the electrode assembly 30, the current collector 58, and the lead tab 60 may be transferred to a next process (e.g., an assembly process) (180), and if the total height measurement is determined to be insufficient, the welded assembly may be determined to be a defective product and discharged (190).

An embodiment of an apparatus for manufacturing a cylindrical battery according to the present disclosure, which has been described with reference to the drawings, will be described as follows.

The apparatus for manufacturing a cylindrical battery may include a unit for positioning and arranging a current collector on an uncoated portion of an electrode assembly including an electrode plate on which the uncoated portion is formed (For example, the unit may include a mechatronic device that picks up a current collector loaded in a specific area, moves it toward the electrode assembly, and places the current collector on the uncoated portion of the electrode assembly; an object (i.e., the current collector) alignment device using an image process, physical sensor, etc.; or the like), a unit for positioning and arranging a lead tab on the current collector (For example, the unit may include a mechatronic device that picks up a lead tab loaded in a specific area and moves it onto the current collector and places it on the current collector; an object (i.e., the lead tab) alignment device using an image process, physical sensor, etc.; or the like), a pressing pusher, e.g., driven by electric actuators or hydraulic devices, configured to press the current collector to be in close contact with the lead tab, and an electrically connecting unit (the unit may include, for example, a welder using laser, electricity, ultrasonic, etc.) for electrically connecting the uncoated portion, the current collector, and the lead tab.

In some embodiments, the apparatus for manufacturing a cylindrical battery may further include a unit for inspecting an arrangement state of the current collector (e.g. automatic or human-eye vision test equipment).

In some embodiments, the apparatus for manufacturing a cylindrical battery may further include a unit for inspecting an arrangement state of the lead tab (e.g. automatic or human-eye vision test equipment).

In some embodiments, the pressing pusher may have a first opening which opens (or exposes) an electrically connected portion of the uncoated portion and the current collector and a second opening which opens (or exposes) an electrically connected portion of the current collector and the lead tab.

In addition, in some embodiments, the apparatus for manufacturing a cylindrical battery may further include a unit for measuring the total height of the electrode assembly, the current collector, and the lead tab, on which electrically connecting is completely performed. (For example, laser rangefinders, optical rangefinders, conventional rulers, etc.)

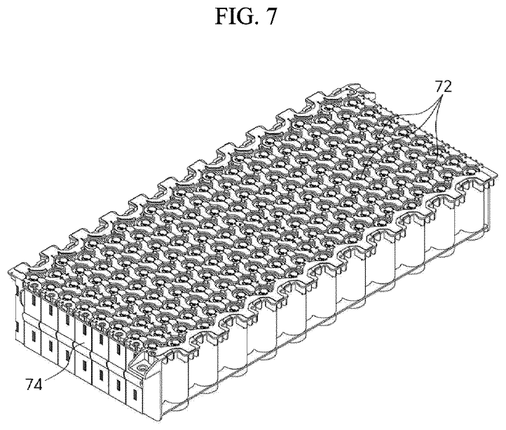

FIG. 7 is a diagram illustrating a secondary battery module in which cylindrical secondary battery cells according to embodiments of the present disclosure are arranged. To increase secondary battery capacity for driving electric vehicles, a plurality of secondary battery cells 72 may be arranged in a module case 74 and disposed and connected in a horizontal direction and/or a vertical direction to manufacture a secondary battery module. The arrangement direction and number of the secondary battery cells 72 may be designed to achieve desired voltage and current specifications.

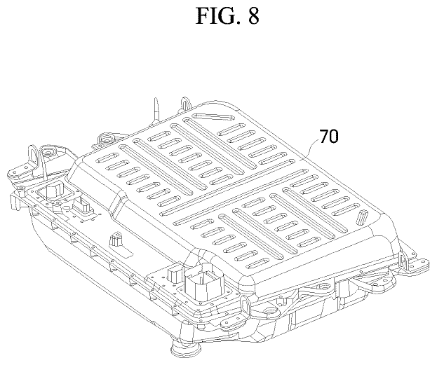

FIG. 8 is a diagram illustrating a secondary battery pack 70 formed to apply the secondary battery module shown in FIG. 7 to an actual product (e.g., a vehicle). The secondary battery pack may be manufactured by embedding a plurality of secondary battery modules into a pack housing designed to be mounted in a product. The pack housing may include fasteners and electrical outlets necessary for mounting to the product. In FIG. 8, for convenience of illustration, related elements, such as bus bars for electrical connection of the secondary batteries, cooling units, and external terminals are omitted.

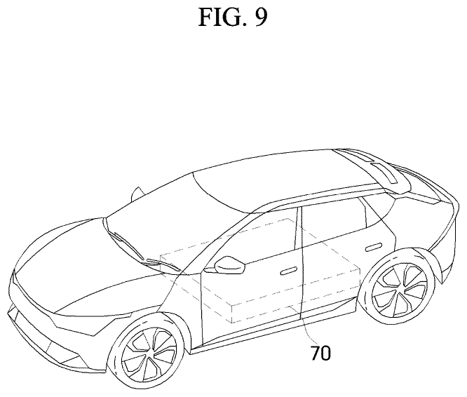

The secondary battery pack may be mounted on a vehicle. The vehicle may be, for example, an electric vehicle, a hybrid vehicle, or a plug-in hybrid vehicle. The vehicle may include a four-wheel drive or two-wheel drive vehicle. FIG. 9 is a diagram schematically illustrating a vehicle including the secondary battery pack shown in FIG. 8. FIG. 9 illustrates the secondary battery pack 70 according to one embodiment of the present disclosure mounted on a lower portion of a vehicle body of a vehicle. The vehicle operates by receiving power from the secondary battery pack 70 according to one embodiment of the present disclosure.

According to embodiments of the present disclosure, because electrically connecting can be performed on an electrode assembly, a current collector, and a lead tab in a cylindrical secondary battery by one-time (e.g., single-step) process, the number of electrically connecting facilities, for example, welders and welding stations, can be reduced from two in the related art to one, and time required for moving, seating, and arranging a member to be welded can be reduced, thereby improving productivity and achieving an effect of reducing production costs.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

What is claimed is:

1. A method of manufacturing a cylindrical secondary battery, the method comprising:
manufacturing an electrode assembly comprising an electrode plate having an uncoated portion;
positioning and arranging a current collector on the uncoated portion of the electrode assembly;
positioning and arranging a lead tab on the current collector; and
electrically connecting the uncoated portion, the current collector, and the lead tab.

2. The method as claimed in claim 1, further comprising inspecting an arrangement of the current collector.

3. The method as claimed in claim 1, further comprising inspecting an arrangement of the lead tab.

4. The method as claimed in claim 1, further comprising, before the electrically connecting, pressing the current collector and the lead tab to bring the current collector into close contact with the lead tab.

5. The method as claimed in claim 4, wherein the pressing is performed by using a pressing pusher.

6. The method as claimed in claim 5, wherein the pressing pusher has a first opening exposing an electrically connected portion of the uncoated portion and the current collector and a second opening exposing an electrically connected portion of the current collector and the lead tab.

7. The method as claimed in claim 1, further comprising, after the electrically connecting, measuring a total height of the electrode assembly, the current collector, and the lead tab.

8. The method as claimed in claim 1, wherein the electrically connecting the uncoated portion, the current collector, and the lead tab comprises electrically connecting the uncoated portion, the current collector, and the lead tab by using a welder.

9. An apparatus for manufacturing a cylindrical secondary battery, the apparatus comprising:
a unit configured to position and arrange a current collector on an uncoated portion of an electrode plate of an electrode assembly;
a unit configured to position and arrange a lead tab on the current collector;
a pressing pusher configured to press the current collector to be in close contact with the lead tab; and
an electrical connecting unit configured to electrically connecting the uncoated portion, the current collector, and the lead tab together.

10. The apparatus as claimed in claim 9, further comprising a unit configured to inspect an arrangement of the current collector.

11. The apparatus as claimed in claim 9, further comprising a unit configured to inspect an arrangement of the lead tab.

12. The apparatus as claimed in claim 9, wherein the pressing pusher has a first opening exposing an electrically connecting portion of the uncoated portion and the current collector and a second opening exposing an electrically connecting portion of the current collector and the lead tab.

13. The apparatus as claimed in claim 9, further comprising a unit configured to measure a total height of the electrode assembly, the current collector, and the lead tab that have been electrically connected together.

14. The apparatus as claimed in claim 9, wherein the electrically connecting unit comprises a welder for welding the uncoated portion, the current collector, and the lead tab.

15. A secondary battery comprising:
a case;
an electrode assembly accommodated in the case, the electrode assembly including a first electrode, a separator, and a second electrode;
a current collector electrically connected to an uncoated portion of the first electrode of the electrode assembly, on which no active material is applied;
a lead tab electrically connected to the current collector; and
a terminal electrically connected to the lead tab.

16. The secondary battery as claimed in claim 15, wherein the current collector electrically connected to the uncoated portion of the first electrode of the electrode assembly and the lead tab electrically connected to the current collector are
electrically connected by welding.

17. The secondary battery as claimed in claim 15, further comprising:
a second current collector electrically connected to the second uncoated portion of the second electrode of the electrode assembly, on which no active material is applied;
a second lead tab electrically connected to the second current collector; and
a second terminal electrically connected to the second lead tab.

18. The secondary battery as claimed in claim 17, wherein the second current collector electrically connected to the second uncoated portion of the second electrode of the electrode assembly and the second lead tab electrically connected to the second current collector are
electrically connected by welding.

19. A pressing pusher comprising a part configured to bring an uncoated portion of an electrode assembly of a secondary battery, a current collector positioned and arranged on the uncoated portion, and a lead tab positioned and arranged on the current collector that are brought into close contact with each other before electrically connecting is performed thereon.

20. The pressing pusher as claimed in claim 19, further comprising a first opening exposing an electrically connecting portion of the uncoated portion and the current collector and a second opening exposing an electrically connecting portion of the current collector and the lead tab.
